(19) United States
(12) Patent Application Publication
(10) Pub. No.: US 2007/0071565 A1
(43) Pub. Date: Mar. 29, 2007

(54) HOLE SAW MANDREL

(76) Inventors: Satnam Singh, Kitchener (CA); Kailash C. Vasudeva, Waterloo (CA); Randy Schnarr, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/536,287

(22) Filed: Sep. 28, 2006

Related U.S. Application Data
(60) Provisional application No. 60/721,101, filed on Sep. 28, 2005.

(51) Int. Cl. B23B 51/04

(52) U.S. Cl. 408/204

(57) ABSTRACT

The present invention is directed at a hole saw mandrel which is used to connect a drill with a hole saw. The mandrel includes a tool end for connecting the hole mandrel with the drill; a hole cutting end including a hole saw receiving means and a drill bit receiving means; and a central portion connecting the tool end to the hole cutting end; wherein the hole saw receiving means comprising a collar which is independent of the central portion so that no play is experienced between a hole saw and the hole saw mandrel when the hole saw is in use. The hole saw mandrel may also include an ejector to eject a slug from the hole saw after a hole has been cut.

### CROSS REFERENCE TO RELATED APPLICATIONS

This application claims the benefit of priority of U.S. Provisional Patent Application No. 60/721,101 filed Sep. 28, 2005, which is incorporated herein by reference.

### FIELD OF THE INVENTION

The present invention relates generally to hole saws. More particularly, the present invention relates to a hole saw mandrel with no play for an attached hole saw.

### BACKGROUND OF THE INVENTION

Currently, hole saws in the market provide the means for an individual to cut a circular hole through various materials such as wood or metal. However, the removal of the hole saw from a mandrel after use is quite dangerous and users are prone to injury. For instance, if the user attempts to remove the hole saw immediately after use, the temperature of the hole saw may be quite high therefore burning the fingers of the user as he/she attempts to unattach the hole saw from the mandrel. Furthermore, the process to detach the hole saw from the hole saw mandrel (even after the hole saw has cooled down) is quite cumbersome as injuries such as the user cutting their fingers/hand on the teeth of the hole saw may occur.

Furthermore, after a user has cut a hole with the hole saw, the slug generally remains in the hole saw. Therefore, in order for the user to cut another hole, the user must manually remove the slug before attempting to cut a second hole. Attempted removal of the slug immediately after the hole has been cut may lead to the injuries described above with respect to the detachment of the hole saw from the hole saw mandrel. The option of waiting for the hole saw to cool down before removing the slug results in the user's time as they are waiting for the hole saw to cool down.

Another disadvantage of current hole saw mandrels is that there tends to be an amount of play between the hole saw and the hole saw mandrel typically resulting in a loose running hole saw while the hole is being cut. This tends to result in a hole that is larger than the expected size and in a field where precision cutting is required, this is not acceptable. Another disadvantage is that binding may occur while the hole saw is cutting the hole if there is play between the hole saw and the hole saw mandrel.

It is, therefore, desirable to provide a novel hole saw mandrel

### SUMMARY OF THE INVENTION

It is an object of the present invention to obviate or mitigate at least one disadvantage of previous hole saw mandrels. In one embodiment, the hole saw mandrel provides a user with hands-free release means so that the user does not have to touch the hole saw to remove it from the hole saw mandrel. This is especially beneficial when the user wishes to quickly remove a hole saw after use with the hole saw being hot to the touch. Another embodiment of the hole saw mandrel provides an ejector for ejecting a slug from the hole saw after a hole is cut. A further aspect of the invention is to reduce or eliminate play between the hole saw mandrel and the hole saw while the hole saw is in operation.

In a first aspect, the present invention provides A hole saw mandrel comprising a tool end for connecting the hole mandrel with a drill; a hole cutting end, connected to the tool end, including a hole saw receiver and a drill bit receiver; and the hole saw receiver further including means for reducing or eliminating play between a hole saw and the hole saw mandrel when the hole saw is in use.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1a to 1c are schematic diagrams of an embodiment of a hole saw mandrel in accordance with the invention;

FIGS. 2a to 2c are schematic diagrams of another embodiment of a hole saw mandrel in accordance with the invention;

FIGS. 3a to 3c are schematic diagrams of a further embodiment of a hole saw mandrel in accordance with the invention;

FIGS. 4a to 4c are schematic diagrams of a fourth embodiment of a hole saw mandrel in accordance with the invention;

FIGS. 5a to 5c are schematic diagrams of a fifth embodiment of a hole saw mandrel in accordance with the invention; and

FIGS. 6a to 6c are schematic diagrams of a sixth embodiment of a hole saw mandrel in accordance with the invention.

### DETAILED DESCRIPTION

Generally, the present invention provides a novel hole saw mandrel which overcomes disadvantages of prior art hole saw mandrels. In one embodiment, the hole saw mandrel reduces the amount of play between the hole saw and the hole saw mandrel while the hole saw is in use. In another embodiment, the hole saw mandrel provides ejection means for assisting in removing the slug from the hole saw after a hole is cut.

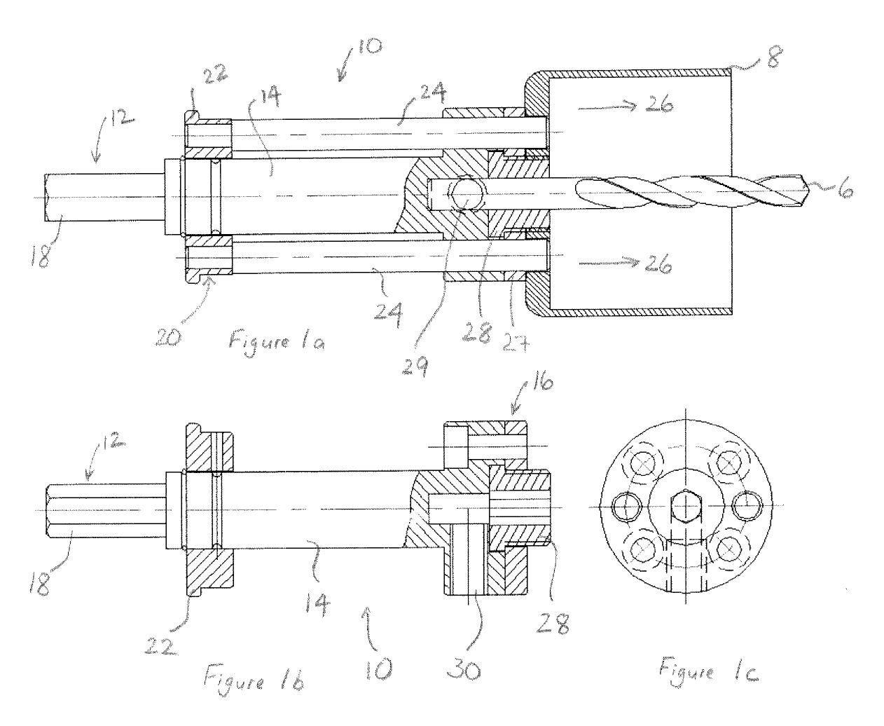

Turning to FIGS. 1a to 1c, schematic diagrams of an embodiment of a hole saw mandrel 10 (with an attached hole saw 8 and an attached drill bit 6) in accordance with the invention is shown. The hole saw mandrel 10 comprises a tool end 12, a central portion 14 and a hole cutting end 16. The tool end 12 includes a connecting bar 18 which serves as a means to connect or mount the hole saw mandrel within a drill (not shown). The connecting bar 18 is typically chucked into the drill. Also located at the tool end 12 (when in a non-ejection position) is an ejector 20 comprising an ejecting collar 22 and a pair of ejecting pins 24 connected to the ejecting collar 22. The ejecting collar 22 includes a central hole through which the central portion 14 passes thereby allowing the ejecting collar to slide back and forth over the central portion 14. In order to eject a slug, the ejecting collar 22 is urged towards the hole cutting end 16 (as shown by arrows 26) causing the pins 24 to pass through the hole saw B thereby ejecting the slug. As will be understood, the bottom of the hole saw 8 includes holes for receiving the ejecting pins 24.

The central portion 14 serves a connector between the tool end 12 and the hole cutting end 16.

The hole cutting end 16 includes a hole saw receiving means or hole saw receiver, such as threaded collar 28, which is independent of the central portion 14 and mates with a corresponding threaded portion in the hole saw 8. In order to attach the drill bit 6, the drill bit 6 is inserted through the threaded collar 28 into the central portion 14 and is then locked in place via a threaded locking means 29 seen as a threaded hole in FIG. 1b. The threaded locking means 29 typically receives a set screw which allows a user to tighten and loosen the drill bit 6.

In the preferred embodiment, the threaded collar 28 preferably rotates independently of the central portion 14 enabling the threaded collar 28 to be tightened to reduce or eliminate play between the hole saw 8 and the hole saw mandrel 10 when the both are in operation. A reduction/elimination of play is also provided when the hole saw 8 is attached and has its back placed in direct contact with a backing plate 27. By positioning the backing plate 27 to abut the back of the hole saw 8, the hole saw is restricted from anything but rotational movement during operation. The hole saw 8 also includes a pair of holes which are aligned with and receive the ends of the ejecting pins 24 (in the non-ejected position) to further reduce or eliminate play between the hole saw 8 and the hole saw mandrel 10. The positioning of the ends of the pins 24 also provides further assistance in driving the hole saw during operation.

After a hole has been cut by the hole saw 8, the slug may be easily removed from the hole saw 8 by urging the ejecting collar 22 from the tool end 12 towards the hole cutting end 16. This may be easily achieved by hand or by a light tapping of the ejecting collar 22 from a tool such as a hammer. The movement of the ejecting collar 22 causes the pair of pins 24 to also move through the holes thereby contacting the slug and forcing the slug out of the hole saw 8. After the slug has been removed, the user may then proceed to cut another hole. At this point, if necessary, the drill bit 6 may also be removed or changed.

If the hole saw is to be removed after the slug is removed, in order to protect the user's hands from possible injury (as the metal hole saw is generally hot), in this embodiment, the hole saw mandrel 10 allows for no-touch removal of the hole saw 8. The means for receiving the hole saw 28 allows the hole saw 8 to be easily mounted by hand to the hole saw mandrel 10 but also allows the hole saw 8 to be removed via a hex key so that there is no contact between the user's hand and the hole saw 8. After the drill bit 6 has been removed, a hex key may then be inserted into the hole saw 8 to unthread the hole saw 8 from the threaded collar 28. After the hole saw 8 has been unthreaded, the user may simply turn the mandrel 10 upside down so that the hole saw 8 simply drops off. In this manner, the hole saw 8 is detached, or unthreaded without the user having to touch the hole saw 8.

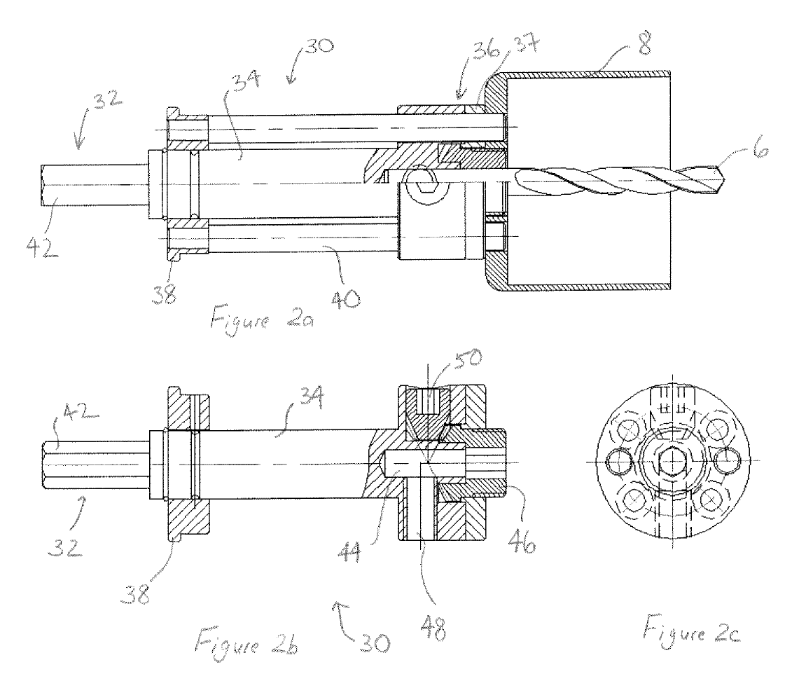

Turning to FIGS. 2a to 2c, a second embodiment of a hole saw mandrel in accordance with the invention is shown. The hole saw mandrel 30 is similar to the embodiment of FIGS. 1a to 1c and comprises a tool end 32, a central portion 34 and a hole cutting end 36. The hole saw mandrel 30 is used to receive a hole saw 8 and a drill bit 6.

The hole saw mandrel 30 further comprises means for ejecting a slug from the hole saw 8, or an ejector, comprising an ejecting collar 38 connected to a pair of ejecting pins 40 and a means for mounting the hole saw mandrel 30 to a drill (not shown) such as a connecting bar 42. The connecting bar 42 is typically chucked in the drill as will be understood by one skilled in the art. The hole cutting end 36 comprises a drill bit receiving means, such as hole 44, and a hole saw receiving means 46. In this embodiment, the hole saw receiving means 46 is preferably a no-play threaded collar although other no-play connection means may be used and are contemplated. As with the previous embodiment, the amount of play between the hole saw and the hole saw mandrel is reduced or eliminated by having the back of the hole saw abut a backing plate 37 after it has been attached to the hole saw mandrel 30. The drill bit 6 and the hole saw 8 are shown connected to the hole saw mandrel 30 in FIG. 2a. A threaded hole 48, located at the hole cutting end 36, accepts a set screw which is used to tighten/loosen the drill bit 30 after it has been inserted into the hole 44.

The ejecting collar 38 operates in the same manner as the ejecting collar 22 to remove the slug from the hole saw 8 after the hole has been cut. By moving the ejecting collar 38 away from the tool end 32 (the non-ejection position) towards the hole cutting end 36 (the ejection position), the ejecting pins 40 move in a similar direction to push, or eject, the slug out of the hole saw 8 without the user having to touch the hole saw 8 thereby reducing the chance of injury.

After operation, the hole saw 8 may also be removed from the hole saw mandrel 30 in a hands-free manner. A hex key is inserted into a gear 50 to turn the gear 60. The rotational movement of the hex key is then translated by the gear 50 to unthread the hole saw 8 from the threaded connector 46. Once the hole saw 8 is unthreaded, or detached, it may be removed without having to touch the hole saw 8 by pointing the drill downwards (causing the hole saw 8 to also point downwards) and allowing gravity to pull the hole saw 8 away from the hole saw mandrel 30.

As further shown in FIG. 2a, the ends of the ejecting pins 40, when in the non-ejection position, are located within a pair of holes in the base of the hole saw 8 to further assist in reducing, or eliminating, play between the hole saw and the hole saw mandrel.

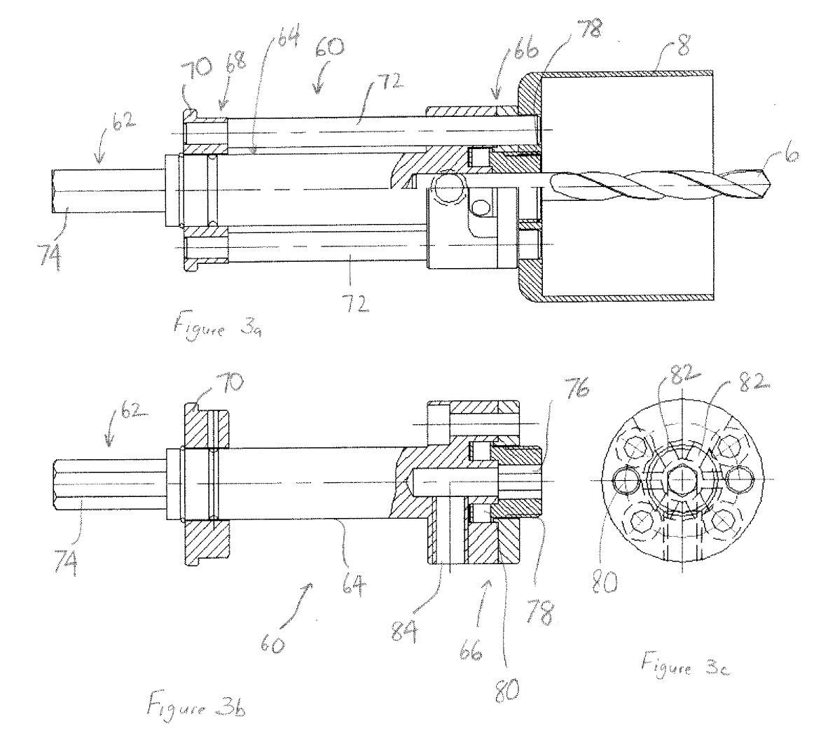

Turning to FIGS. 3a to 3c, yet a further embodiment of a hole saw mandrel in accordance with the invention is shown. In this embodiment, the removal of the hole saw 8 after the hole has been cut is assisted by a cog-like system. This may be performed with or without a ratchet-like system, as will be described. The hole saw mandrel 60 comprises a tool end 62, a central portion 64 and a hole cutting end 66. The hole saw mandrel 60 further comprises an ejector 68, comprising an ejecting collar 70 and a set of ejecting pins 72.

The tool end 62 includes a means for mounting the hole saw mandrel to a drill, such as connecting bar 74. The connection bar 74 is preferably chucked in the drill and is locked in place via known means. The hole cutting end 66 comprises a drill bit receiving means 76 and a hole saw receiving means 78. In order to attach the drill bit 6, the drill bit is inserted through the hole saw receiving means 78 into the central portion 64. The drill bit 6 may be locked or released from the central portion by inserting a set screw in hole 84 or by other known methods. The drill bit 6 and the hole saw 8 are shown attached to their respective receiving means in FIG. 3a.

Similar to the previous embodiments, the slug may be removed by moving the ejecting collar 70 from the tool end 62 towards the hole cutting end 66, which causes the pins 72 to push the slug out of the hole saw 8 after the hole has been cut.

In order to detach the hole saw 8 from the hole saw mandrel 60, a key, or pole, is inserted into a hole 80, through one of a plurality of slots 82 in the mandrel 60. The user may then unthread the hole saw 8 from the hole saw receiving means 78 by using the key, or pole, to rotate the slots 82, thereby unthreading the hole saw 8 from the hole saw mandrel 60.

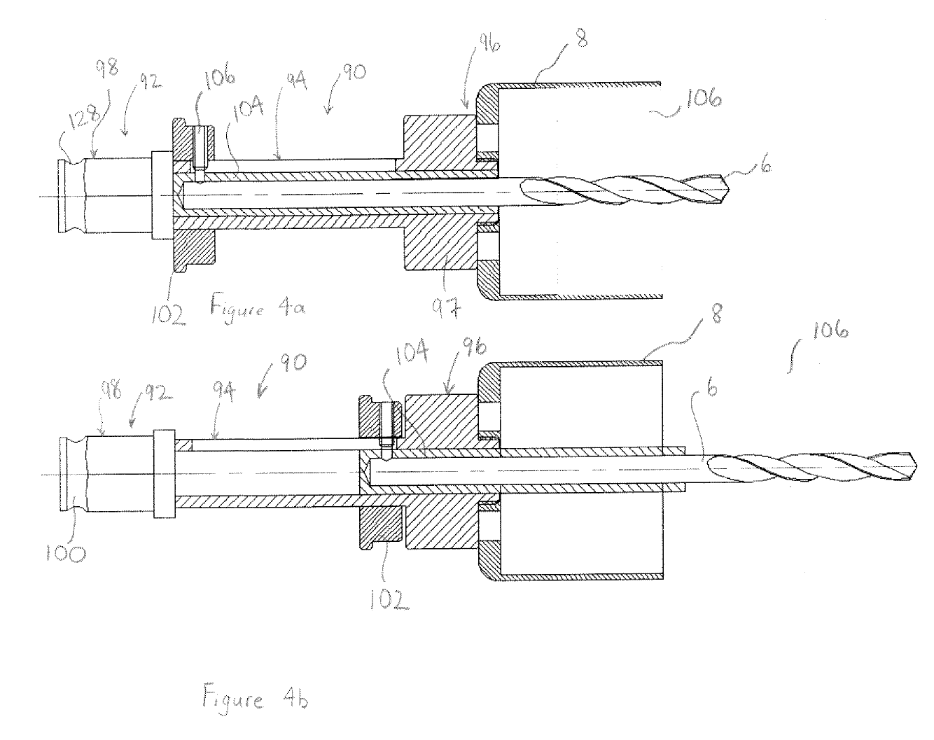

Turning to FIGS. 4a and 4b, yet a further embodiment of a hole saw mandrel is shown. The present embodiment is preferably used with smaller sized hole saws as they do not include holes for receiving ejecting pins. The hole saw mandrel 90 comprises a tool end 92, a central portion 94 and a hole cutting end 96. The tool end 92 includes a connecting means 98 for connecting the hole saw mandrel to a drill which is preferably a quick connect means 100 so that the hole saw mandrel 90 may be quickly connected and removed from the drill, when required.

The hole saw mandrel 90 further comprises an ejector for ejecting a slug from the hole saw 8 comprising an ejection collar 102 and a sleeve 104. The ejection collar 102 preferably includes a central hole so that the collar 102 may slide back and forth along the central portion 94 of the hole saw mandrel 90. The ejection collar 102 is connected to the sleeve 104 which also houses the drill bit 6. A hole 106 in the ejection collar 102 provides access to the drill bit 6 so that a user may easily lock the drill bit to or unlock the drill bit from the hole saw mandrel 90. After the hole has been cut, by moving the ejection collar 102 away from the tool end 92 (the non-ejection position) towards the hole cutting end 96 (the ejection position), the sleeve 104 is urged in the same direction. The sleeve 104 comes in contact with the slug and then ejects the slug. As can be seen from FIGS. 4a and 4b, the hole saw 8 includes a hole through which the sleeve 104 may slide in order to eject the slug.

As with some of the embodiments, the hole saw mandrel 90 also comprises a hole saw receiving means 108 which is independent of the central portion 94 thereby reducing or eliminating the amount of play between the hole saw 8 and the hole saw mandrel 90 when the hole saw is in use. By having the back of the hole saw 8 abut a backing plate 97, non-rotational movement of the hole saw 8 is restricted during use.

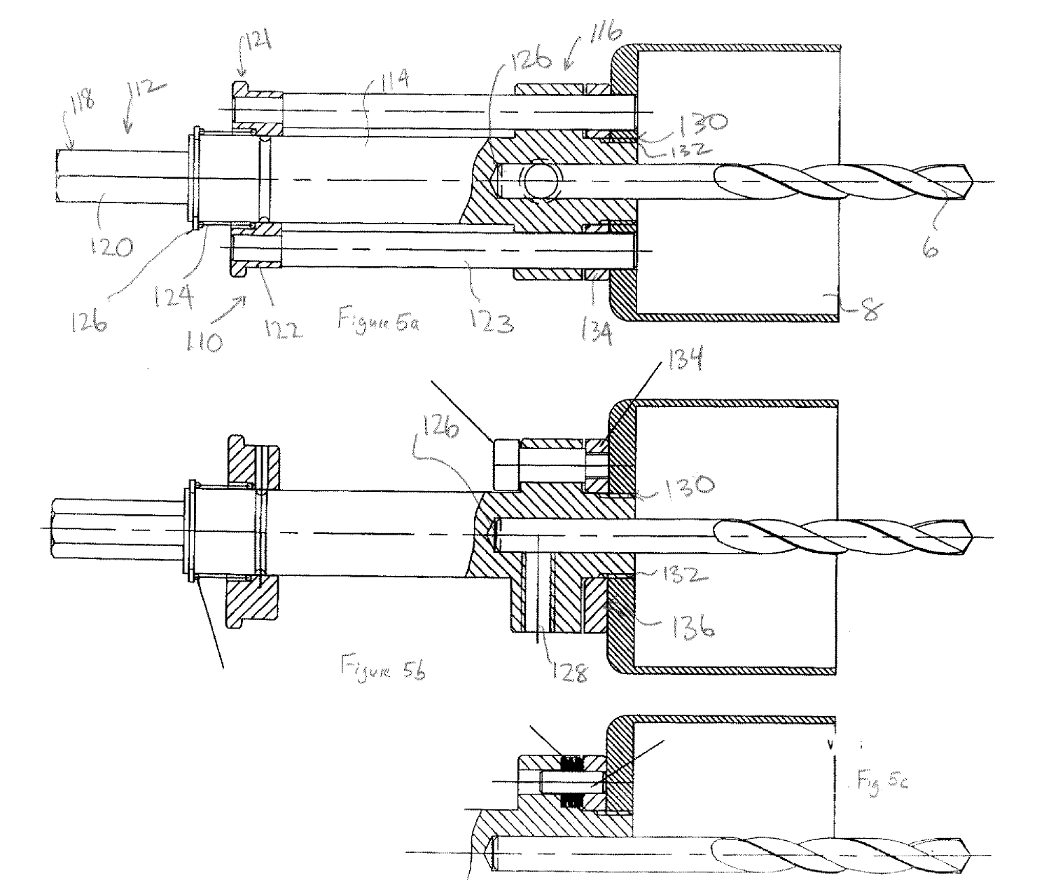

Turning to FIGS. 5a to 5c, yet another embodiment of a hole saw mandrel is shown. The hole saw mandrel 110 comprises a tool end 112, a central portion 114 and a hole cutting end 116. The tool end 112 includes a drill connecting means 118 such as connecting bar 120 which is typically chucked into the drill. The hole saw mandrel 110 also comprises an ejector 121 comprising an ejecting collar 122 connected to a pair of ejecting pins 123.

A spring 124 is located between the ejecting collar 122 and a retaining ring 126, acting as a base plate. The ejecting collar 122 includes a central hole for receiving the central portion 114 so that the ejecting collar 122 may slide along the central portion 114 from the non-ejection position to the ejection position to remove the slug, when necessary.

The drill bit is received within a drill bit receiving means 126 in the hole cutting end 116 and locked in place by the insertion of a set screw into hole 128. A hole saw receiving means 130, preferably in the form of a threaded portion 132, mates with complimentary threading in the base of the hole saw.

In the non-ejection position, the ends of the ejecting pins 123 are located past a pressure, or stop, plate 134 and held in place by the spring 124. The stop plate 134 is also used to provide a drive to the hole saw 8. In order for the hole saw to be threaded on to or off of the hole saw mandrel 110, the ejecting collar 122 is pulled or urged back towards the retaining ring 126 to a hole saw attachment position against the spring 124 so that the ends of the ejecting pins 123 are flush with a hole saw surface 136 of the stop plate so that there is no interference as the hole saw is attached to the hole saw mandrel. In one embodiment, after the hole saw is attached, the ejecting collar 122 may be released so that the force of the spring 124 causes the ends of the ejecting pins 123 to protrude into the base of the hole saw thereby providing assistance in reducing or eliminating the play between the hole saw 8 and the hole saw mandrel 110 and to provide a driving force during the hole cutting process.

In another use, as the hole saw is being attached to the hole saw mandrel, as the hole saw mandrel is almost completed threaded the user may release the ejecting collar so that the ejecting pins 123 abut the back of the hole saw but then protrudes through the holes in the hole saw as the rotation of the hole saw causes the holes to align with the position of the ejecting pins 123, thereby providing an auto-locking function.

As before, the slug may be easily ejected by urging the ejecting collar 122 from the tool end 112 towards the hole cutting end 116 after the hole has been cut causing the ejecting pins 123 to contact the slug and eject it from the hole saw.

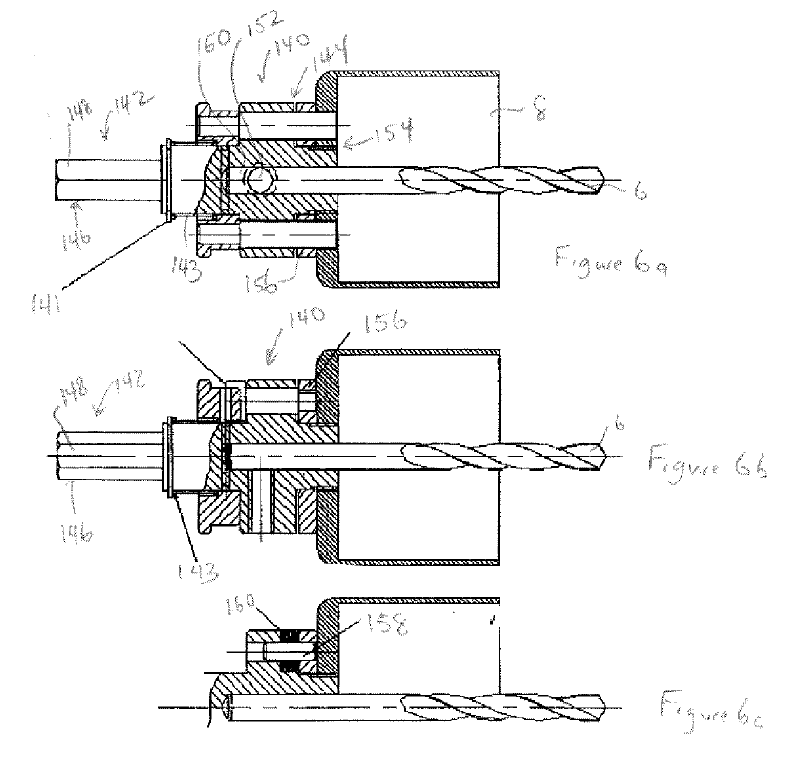

Turning to FIG. 6a to 6c, a sixth embodiment of a hole saw mandrel is shown. The hole saw mandrel 140 comprises a tool end 142 and a hole cutting end 144. The tool end 142 includes a drill connecting means 146 such as connecting bar 148 which is typically chucked into the drill. The tool end also includes a retaining ring 141 and a spring 143.

Similar to the embodiment of FIG. 5, the hole cutting end 144 comprises a drill bit receiving means 150 in the hole cutting end 144 and locked in place by the insertion of a set screw into hole 152. A hole saw receiving means 154, preferably in the form of a threaded portion, mates with complimentary threading in the base of the hole saw 8.

In order to reduce or eliminate play between the hole saw 8 and the hole saw mandrel 140, a pressure, or stop, plate 156 is located at the hole cutting end 144. A pair of locking pins 158, supported by springs 160, are also located diametrically opposed to each other in the hole cutting end. The positioning of the locking pins 158 corresponds to the position of the holes within the base of the hole saw (in larger sized hole saws). As with the embodiment of FIG. 5, when the hole saw is attached, the locking pins 158 are moved inside from the stop plate 156 and then after the hole saw is attached, or almost fully attached, the locking pins are then released and inserted into corresponding holes.

An advantage of the invention is that in some embodiments, the hole saw receiving means is independent from the central portion thereby assisting in reducing or eliminating play so that a sturdy connection between the hole saw and the hole saw mandrel is experienced. Another advantage of the invention is the combination of the zero play connection along with the means for ejecting the slug (where the hole saw does not have to be touched) which allows the slug to be quickly removed after a hole has been cut.

Although shown and described as a connecting bar in most embodiments, the hole saw mandrel may also be connected to the drill via quick connect means.

Another advantage of the invention is that current hole saws may be attached to the universal hole saw mandrel allowing purchasers to simply purchase the hole saw mandrel without having to purchase a new hole saw.

As will be understood by one skilled in the art, holes saws are generally in two size categories. With the sleeve ejection embodiment of FIGS. 4a and 4b, this embodiment may be incorporated with either hole saw size.

A further advantage is that, although the invention is directed at use with bi-metal hole saws, the mandrel may also be used with other types of hole saws, such as carbon hole saws.

The above-described embodiments of the present invention are intended to be examples only. Alterations, modifications and variations may be effected to the particular embodiments by those of skill in the art without departing from the scope of the invention, which is defined solely by the claims appended hereto

What is claimed is:

1. A hole saw mandrel comprising:
a tool end for connecting said hole mandrel with a drill;
a hole cutting end, connected to said tool end, including a hole saw receiver and a drill bit receiver; and
said hole saw receiver further including means for reducing or eliminating play between a hole saw and said hole saw mandrel when said hole saw is in use.

2. The hole saw mandrel of claim 1 wherein said means for reducing or eliminating play comprises:
a pressure plate; and
a quick locking means.

3. The hole saw mandrel of claim 2 wherein said quick locking means comprises:
a threaded portion for receiving a threaded portion of said hole saw; and
a pair of pins for mating with corresponding holes in said hole saw to lock said hole saw into place.

4. The hole saw mandrel of claim 1 wherein said means for reducing or eliminating play comprises:
a backing plate;
whereby when said hole saw is attached to said hole saw mandrel, a back of said hole saw is placed in direct contact with said backing plate.

5. The hole saw mandrel of claim 1 wherein said hole saw receiver comprises a collar which is independent of said central portion.

6. The hole saw mandrel of claim 5 wherein said collar is threaded.

7. The hole saw mandrel of claim 1 further comprising a central portion for connecting said tool end to said hole cutting end;

8. The hole saw mandrel of claim 1 further comprising:
an ejector for ejecting a slug from said hole saw after a hole has been cut.

9. The hole saw mandrel of claim 8 wherein said ejector further comprises:
an ejecting collar having a central hole allowing said ejecting collar to slide over said central portion; and
a set of ejecting pins, connected to said ejection collar;
wherein when said ejecting collar is moved from a non-ejection position to an ejection position, said pins pass through said hole saw to remove said slug from said hole saw.

10. The hole saw mandrel of claim 9 wherein in said non-ejection position an end of each of said ejecting pins is located within a complimentary hole in a base of said hole saw.

11. The hole saw mandrel of claim 9 further comprising:
a back plate; and
a spring;
said back plate and said spring located at said tool end of said hole saw mandrel causing said ejecting collar to be biased in said non-ejection position;
wherein when a hole saw is to be attached, said ejection collar may be urged away from said hole cutting end to a hole saw attachment position and then returned to said non-ejection position by said spring after said hole saw has been attached.

12. The hole saw mandrel of claim 1 further comprising:
a hole for receiving a set screw in order to lock said drill bit into said hole saw mandrel.

13. The hole saw mandrel of claim 1 further comprising:
release means for receiving a key to provide release of said hand saw from said hand saw mandrel without a user's hands having to touch said hole saw.

14. The hole saw mandrel of claim 13 wherein said release means comprise:
a gear, located in said hole cutting end, for receiving said key;
said gear for translating rotational movement of said key to rotation movement for detaching said hole saw from said collar.

15. The hole saw mandrel of claim 13 wherein said release means comprise:
a set of holes, located in said hole cutting end, for receiving said key;
whereby insertion of said key into said set of holes and rotation of said holes causes said hole saw to detach from said collar in a ratchet-like system.
